(19) United States
(12) Patent Application Publication
(10) Pub. No.: US 2004/0200330 A1
(43) Pub. Date: Oct. 14, 2004

(54) Precision electric miter box

(76) Inventor: James G. Watson, Perry Hall, MD (US)

Correspondence Address: ARMSTRONG, WESTERMAN & HATTORI, LLP, 502 Washinton Avenue, Ste. 220, Towson, MD, 21204, US

(21) Appl. No.: 09/808,686

(22) Filed: Mar. 15, 2001

(51) Int. Cl. B26D 3/02

(52) U.S. Cl. 83/100; 83/485; 83/468.3; 83/468.4

(57) ABSTRACT

A miter box has a housing with support means within the housing for supporting a motor. The motor drives a cutting means. The motor is pivotably disposed with respect to a vertical plane through the housing and is disposed at a desired angular relationship. The motor may be manually moved by the support means. A workpiece is supported on the top of the housing at a selected angular relationship to the cutting means. The workpiece may be miter cut and bevel cut simultaneously.

### CROSS REFERENCE TO RELATED APPLICATIONS

Reference is made to Document Disclosure submitted Jan. 12, 2001 entitled “Dustless Precision Electric Miter box (DPEMB)”.

### BACKGROUND OF THE INVENTION

1. Field of the Invention

The present invention relates to miter boxes and more specifically to a precision miter box with a cutting means powered by an electric motor.

2. Description of Related Art

Miter boxes have been used for many years to reproducibly cut a workpiece at a desired angle. The conventional miter box is a channel-shaped device having diagonal slits in the side walls at angles such as 30° and 45° whereby a saw is placed in the diagonal slits for the desired angle and the saw is guided in cutting the workpiece which is disposed within the channel.

A conventional miter box which additionally has a pivotal bed for cutting compound angles is disclosed by Schramm, II in U.S. Pat. No. 4,461,196. A compound miter box provided with saw guides pivotable about a vertical and horizontal axis used with a hand-operated saw is disclosed by Keddie in U.S. Pat. No. 5,713,258. In U.S. Pat. No. 5,819,619, Miller et al disclose a dust or chip collection system for a compound miter saw which has a powered saw blade. Colberg et al in U.S. Pat. No. 4,270,427 disclose a tool elevation and bevel adjustment mechanism for a direct drive power tool such as a table saw wherein the tool's drive motor is mounted on a plate which is pivotally suspended below the work table of the power tool. The tool is mounted on the rotor shaft of the motor. The plate with the motor mounted thereon is selectively pivotal with respect to the table. The motor is pivotally mounted on the plate for arcuate movement with respect to the plate utilizing an elevation adjustment screw linkage. In U.S. Pat. No. 4,807,506, Audet discloses a saw table having an undercarriage mounted under the table pivotable about an axis adjacent one of its lateral sides and angularly actuated by a handle extending on the side of the table opposite the axle. Sherveglieri, in U.S. Pat. Nos. 5,720,213 and 5,943,932 discloses a bevel table saw comprising a table having a slot for the saw blade. The saw blade can be angled to make beveled cuts in a workpiece mounted on the table. Automatic adjustment of the depth of cut of the saw blade is provided when the saw blade is beveled.

There remains a need for a power driven cutting means which can make precision, reproducible miter cuts and bevel cuts on a workpiece.

### BRIEF SUMMARY OF THE INVENTION

It is an object of the invention to provide a precision miter box which has a powered cutting means to make miter and bevel cuts on the workpiece.

It is a further object of the present invention to provide a miter box in which the cutting means is moved with respect to the workpiece and the cutting means can be placed at a selected angle with respect to the workpiece.

It is still another object of the present invention to provide a miter box having a protective guard over the cutting means.

It is yet another object of the present invention to provide a miter box to which is optionally connected a source of vacuum to remove debris from cutting.

In accordance with the teachings of the present invention, there is disclosed a miter box having a housing having a top surface and a plurality of supporting side walls forming an enclosure. An elongated opening is formed in the top surface of the housing near a first of the supporting side walls. A work-holding member has a first end. The work-holding member is connected to the top surface of the housing such that the work-holding member may be slidably moved with respect to the top surface of the housing to dispose the first end of the work-holding member at a selected angle with respect to the elongated opening in the top surface of the housing. A plurality of spaced-apart support means are disposed in the enclosure under, and approximately parallel to, the elongated opening in the top surface of the housing. An electrically-powered motor is supported on the support means in the enclosure. A cutting means is provided driven by the electrically-powered motor, the cutting means projecting upwardly into the elongated opening in the top surface of the housing. Means are provided to move the electrically-powered motor with the cutting means longitudinally within the elongated opening, wherein a workpiece disposed in the work-holding member and extending over the elongated opening is cut at the predetermined angle corresponding to the selected angle of the work-holding member with respect to the elongated opening.

In further accordance with the teachings of the present invention, there is disclosed a power-driven saw machine for making a miter cut, a bevel cut, or a compound miter-bevel cut in a workpiece, wherein the machine includes a housing, a motor within the housing, and a cutting means driven by the motor and projecting above the housing. The improvement is a support means within the housing for supporting the motor for movement within the housing. The motor is pivotably disposed with respect to a vertical plane through the housing and is arranged at a desired angular relationship relative to the vertical plane whenever a bevel cut of the workpiece is intended. A rod is connected to the motor having an end portion projecting externally of the housing, such that the end portion of the rod may be manually manipulated for moving the motor along the support means within the housing for making a cut in the workpiece. The workpiece is supported on top of the housing and is arranged at an angular relationship relative to the cutting means whenever a miter cut of the workpiece is intended.

In still further accordance with the teachings of the present invention, there is disclosed a miter box having a housing having a top surface and an elongated opening formed in the top surface. At least two spaced-apart curved tracks are formed on the top surface of the housing. A work-holding member has a bottom surface, and at least two spaced-apart protrusions are formed on the bottom surface of the work-holding means. Each of the at least two spaced-apart protrusions are received in a respective track on the top surface of the housing. The work-holding member may be slidably moved and guided to a selected angle with respect to the elongated opening on the top surface of the housing.

These and other objects of the present invention will become apparent from a reading of the following specification taken in conjunction with the enclosed drawings.

### BRIEF DESCRIPTION OF THE DRAWINGS

FIG. 1 is a perspective view of the miter box of the present invention.

FIG. 2 is a top plan view of the housing of the miter box with the work-holding member and the cover not shown.

FIG. 3 is an end view of the work-holding member.

FIG. 4 is a side elevation view of the work-holding member.

FIG. 5 is a top plan view of the work-holding member.

FIG. 6 is a top plan view of the miter box showing the work-holding member at 0° inclination with respect to the elongated opening.

FIG. 7 is a top plan view showing the work-holding member at a −15° inclination with respect to the elongated opening.

FIG. 8 is a top plan view of the miter box showing the work-holding member at a +45° inclination with respect to the elongated opening.

FIG. 9 is a top plan view of the miter box showing the work-holding member at a −30° inclination with respect to the elongated opening.

FIG. 10 is a bottom plan view of the miter box.

FIG. 11 is a side elevation view showing the motor and cutting means longitudinally movable on the support means and showing no rotation of the motor and cutting means.

FIG. 12 is a sectional view taken across the lines 12-12 of FIG. 11.

FIG. 13 is a side elevation view showing the motor and cutting means rotated 45° positively.

FIG. 14 is the end view of FIG. 13 showing the motor and cutting means in broken lines.

FIG. 15 is a sectional view taken across the lines 15-15 of FIG. 13.

FIG. 16 is the view of FIG. 11 having a circular saw blade connected to the motor.

FIG. 17 is the end view of FIG. 16 showing the motor and cutting means in broken lines.

FIG. 18 is the view of FIG. 13 having a circular saw blade connected to the motor.

FIG. 19 is the end view of FIG. 18 showing the motor and cutting means in broken lines.

FIG. 20 is a side elevation view of the frame for the protector.

FIG. 21 is a perspective view of the protector with the cover.

FIG. 22 is a bottom plan view of the protector without the cover.

FIG. 23 is a perspective view showing a vacuum line connected to the miter box.

FIG. 24 is a perspective view showing a long workpiece disposed in the workpiece holder on the miter box with the ends of the workpiece extending outwardly from opposite sides of the miter box.

FIG. 25 is a diagrammatic series of views showing the relationship of the workpiece to the cutting means angled at −45° at different angles of insertion of the workpiece.

FIG. 26 is the diagrammatic series of views of FIG. 25 when the cutting means is at 0°.

FIG. 27 is the diagrammatic series of views of FIG. 25 when the cutting means is at +45°.

FIG. 28 is a perspective view of a workpiece having adjoining bias cuts at different angles.

### DESCRIPTION OF THE PREFERRED EMBODIMENTS

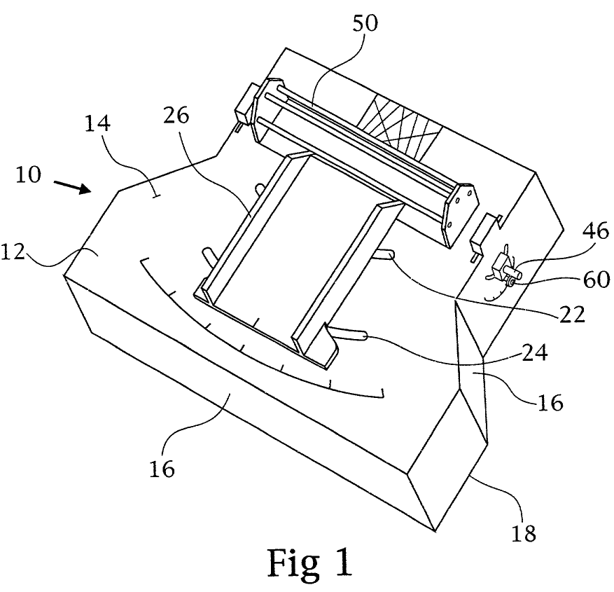

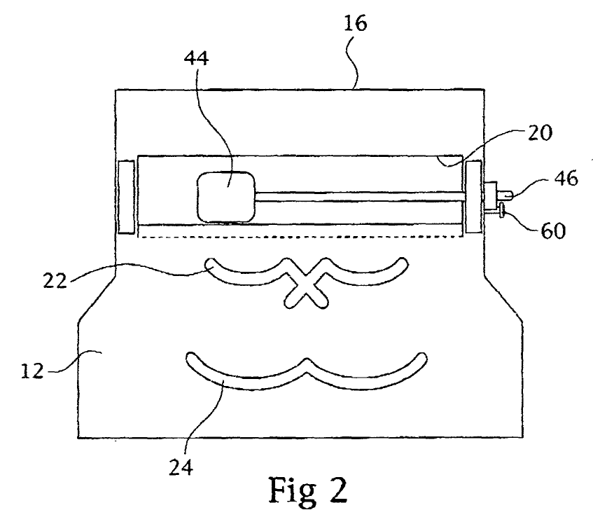

Referring now to FIGS. 1-2, the miter box 10 of the present invention has a housing 12 with a top surface 14 and a plurality of side walls 16. The housing may have four or more side walls 16 to elevate the top surface 14 above a table or other surface and to provide an enclosure 18 for components as will be described.

An elongated opening 20 is formed in the top surface 14 of the housing 12. The elongated opening 20 is near a first supporting wall 16 and extends transversely across the housing 12. A first curved track 22 is disposed in the top surface 14 proximal to the elongated opening 20. Preferably, the first curved track 22 has two portions shaped as inverted letter “L” with curved bases and legs. The leg portions intersect one another. A second curved track 24 is spaced apart from the first curved track 22 and is distal from the elongated opening 20. The second curved track 24 has a chevron shape. The first track 22 and the second track 24 may be a depression or cut out in the top surface 14 of the housing 12 or may be a raised channel mounted on, and extending above, the top surface of the housing 12.

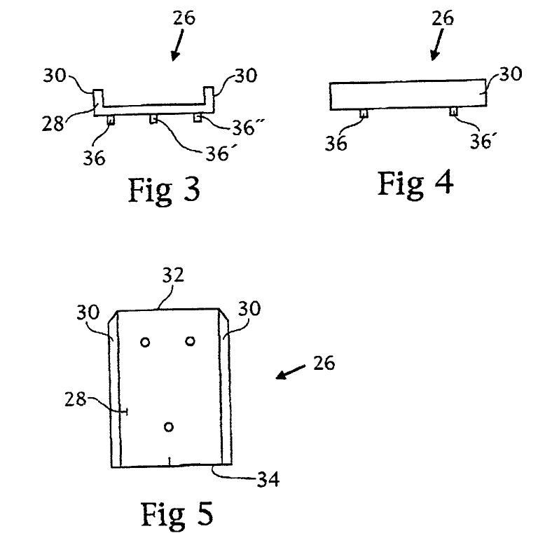

As shown in FIGS. 3-4, a work-holding member 20 has a channel shape with a base 28 and two opposite side walls 30 extending longitudinally on the base 28 between the first end 32 and the second end 34 of the work-holding member 26. The ends 32, 34 are open, having no walls formed thereon. In this manner a workpiece W may be disposed within the work-holding member 26 between the side walls 30 with the workpiece extending from the first end 32 or from both the first end 32 and the second end 34 as there is no restriction on the length of the workpiece W. The work-holding member 26 further has at least two protrusions 36 extending downwardly from the bottom surface of the base 28. The protrusions 30 may be a peg or pin. One protrusion 36, disposed proximal to the second end 34 of the work-holding member 26, is received in the second curved track 24 on the top surface 14 of the housing 12. At least one, and preferably two, protrusions 36 are disposed proximal to the first end 32 of the work-holding member 26. If there are two protrusions 36′, 36″, the protrusions are spaced apart. The protrusions 36′, 36″ are received in the first curved track 22. If there are two protrusions, one protrusion 36′ is received in one of the inverted “L” portions and the other protrusion 36″ is received in the other of the inverted “L” portions. In this manner, the work-holding member 26 is connected to the top surface 14 of the housing 12.

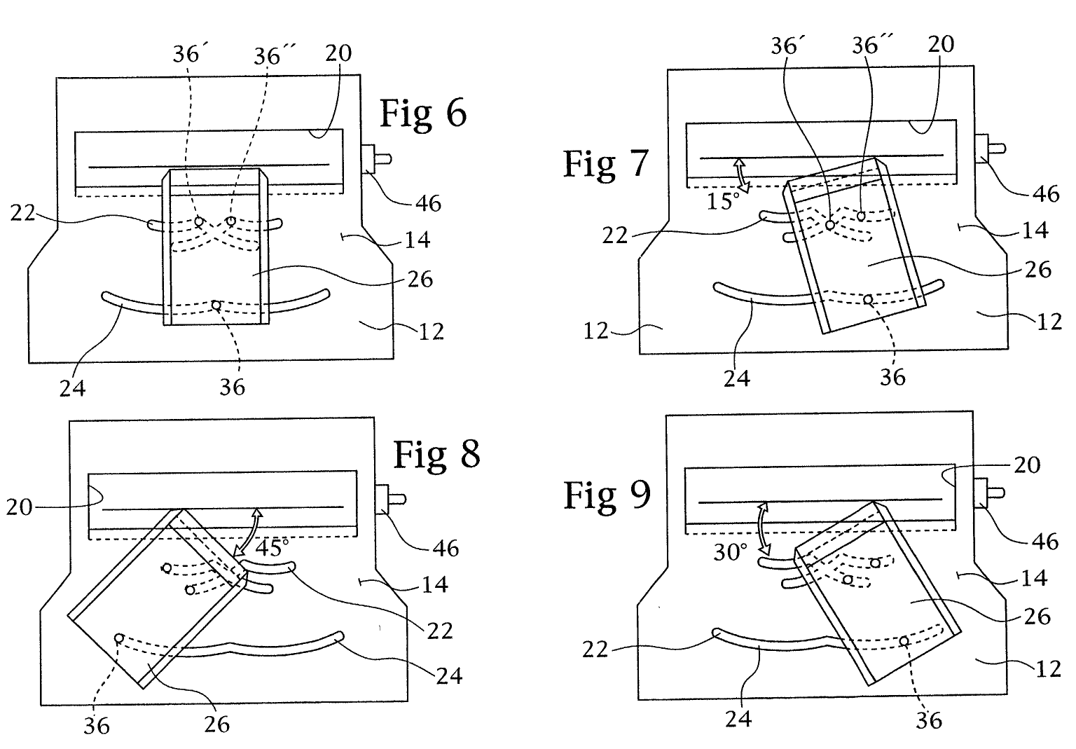

As shown in FIGS. 6-9, due to the configuration of the first curved track 22 and the second curved track 24, the work-holding member 26 may be slidably moved with respect to the top surface 14 of the housing 12. The protrusion 36 near the second end 34 guides the second end of the work-holding member 26 within the second curved track 24. The protrusion(s) near the first end 32, guide the first end of the work-holding member 26 within the first curved track 22. In this manner, the work-holding member 26 may be moved between 45° and −45° with respect to the elongated opening 20. In order to assure a selected angular disposition of the work-holding member 26, an index is placed on the base 26 of the work-holding member 26 and scalar indices are marked on the top surface 14 of the housing 12 such that the index on the base 26 of the work-holding member 26 may be juxtapositioned to the selected angle for cutting the workpiece W as will be described. When so aligned, the first end 22 of the work-holding means 26 is disposed at a corresponding angle with the elongated opening 20.

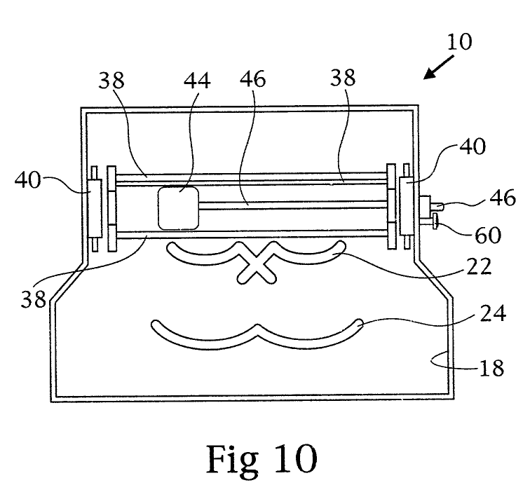

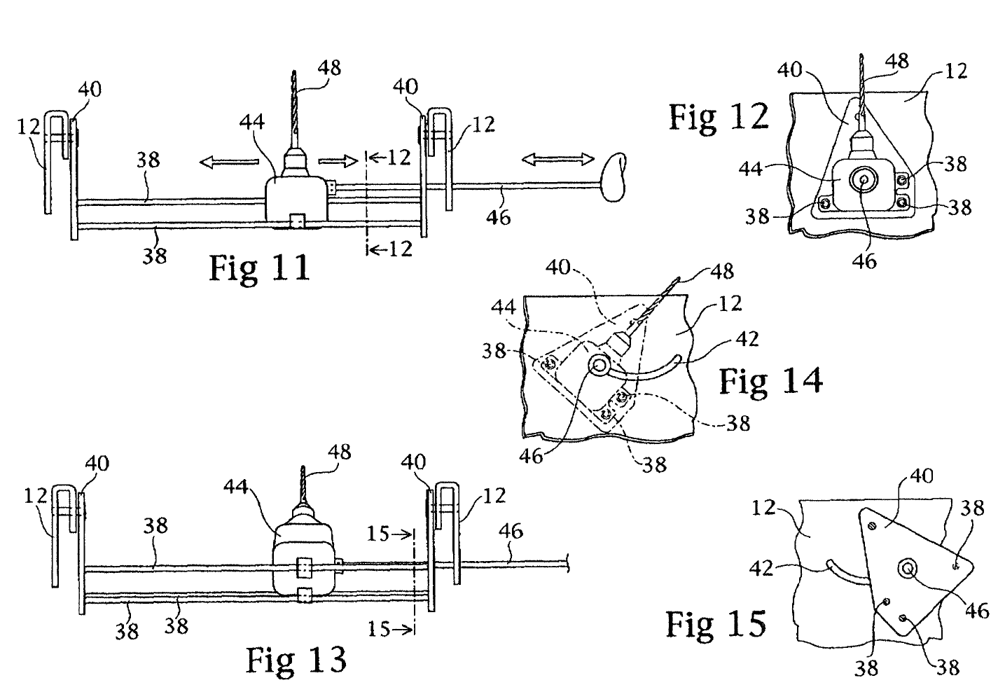

On the underside of the top surface 14 (FIG. 10), within the enclosure 14, are a plurality of spaced-apart support means 38. The support means 38 are under, and approximately parallel with, the elongated opening 20. Preferably, the support means 38 are three rails each having a length greater than the length of the elongated opening 20. As shown in FIGS. 11-14, the opposite ends of each rail is mounted on a respective plate 40. Each plate 40 is pivotally connected to the housing 12.

An electrically-powered motor 44 is slidingly attached to the support means 38. A rod 46 is connected to the motor 44. The rod 46 has an end extending outwardly from the housing 12. Longitudinal movement of the rod 46 with respect to the elongated opening 20 in the top surface 14 produces concomitant sliding movement of the motor 44 along the support means 38.

A cutting means 48 is connected to the motor 44 such that powering of the motor drives the cutting means 48. The cutting means 48 is disposed in the elongated opening 20 in the top surface 14 of the housing 12 and projects upwardly above the horizontal plane of the top surface 14. Thus, any workpiece W held in the workpiece holder 26 and extending over the elongated opening 20 may be contacted by the cutting means 46. The cutting means 46 may be a cutting drill bit, a circular saw blade or any other cutting means known to persons skilled in the art. A cutting drill bit sold by Sears under the name “Saber-cut Zip Bits®” has been found to be useful.

The end of the rod 46 extending outwardly from the housing 12 serves as a handle. The rod 46 passes through an arcuate slot 42 formed in one of the side walls 16 of the housing 12. As the rod 46 is moved angularly with respect to a vertical plane through the elongated opening 20, the plates 40, the support means 38, the motor 44 and the cutting means 48 are all moved through the same selected angle. It is preferred that a scale ranging from −45° through 0° to +45° be formed on the one of the side walls 16 immediately adjacent to the arcuate slot 42. This provides a simple and accurate means to select an angle for bevel cutting the workpiece W. It is also preferred that an electrical switch be mounted on the handle of the rod 46 which is exterior to the housing 12. The electrical switch is electrically connected to the electric motor 44 and the motor 44 can be readily energized when positioned as desired.

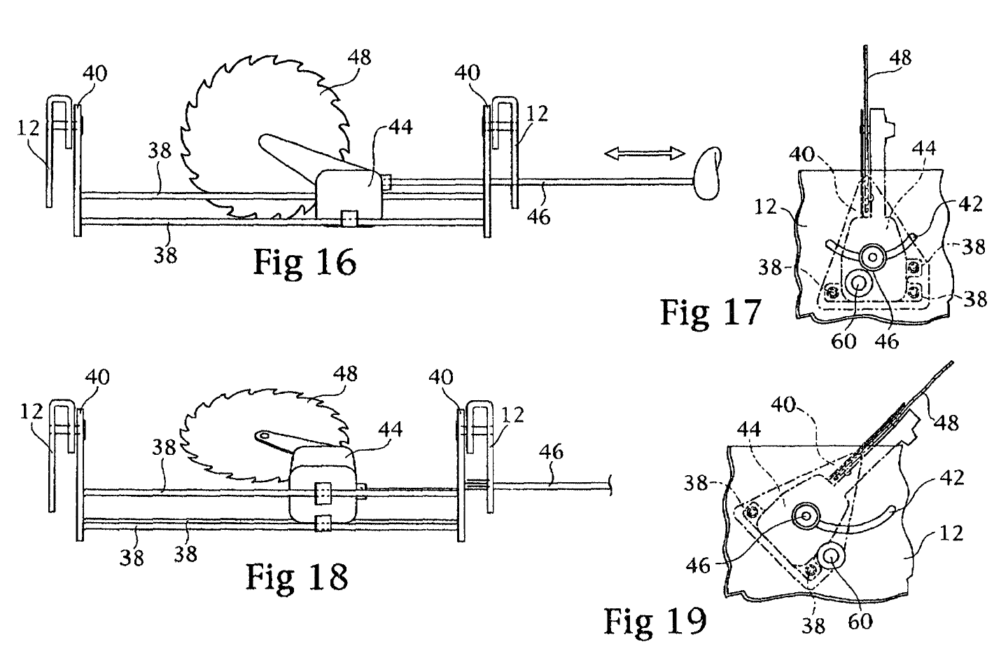

FIGS. 11-15 show a cutting drill bit as the cutting means 48 and FIGS. 16-19 show a circular saw blade on the cutting means 48.

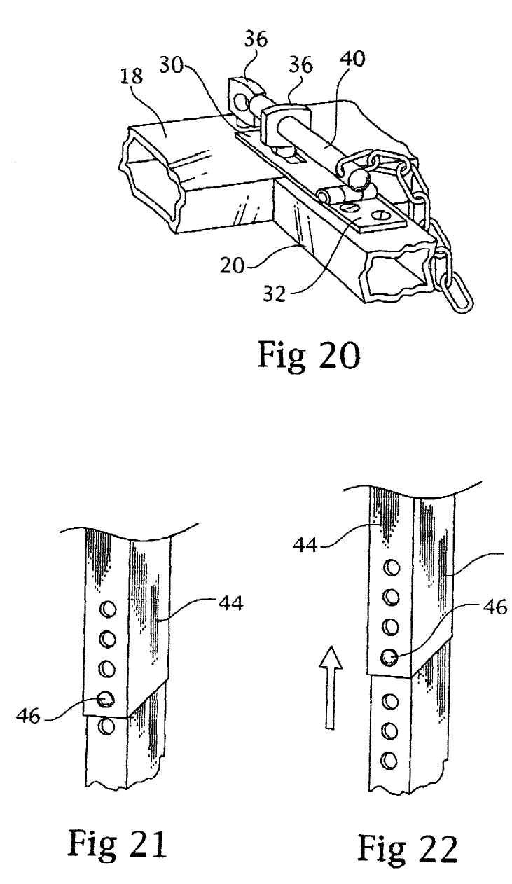

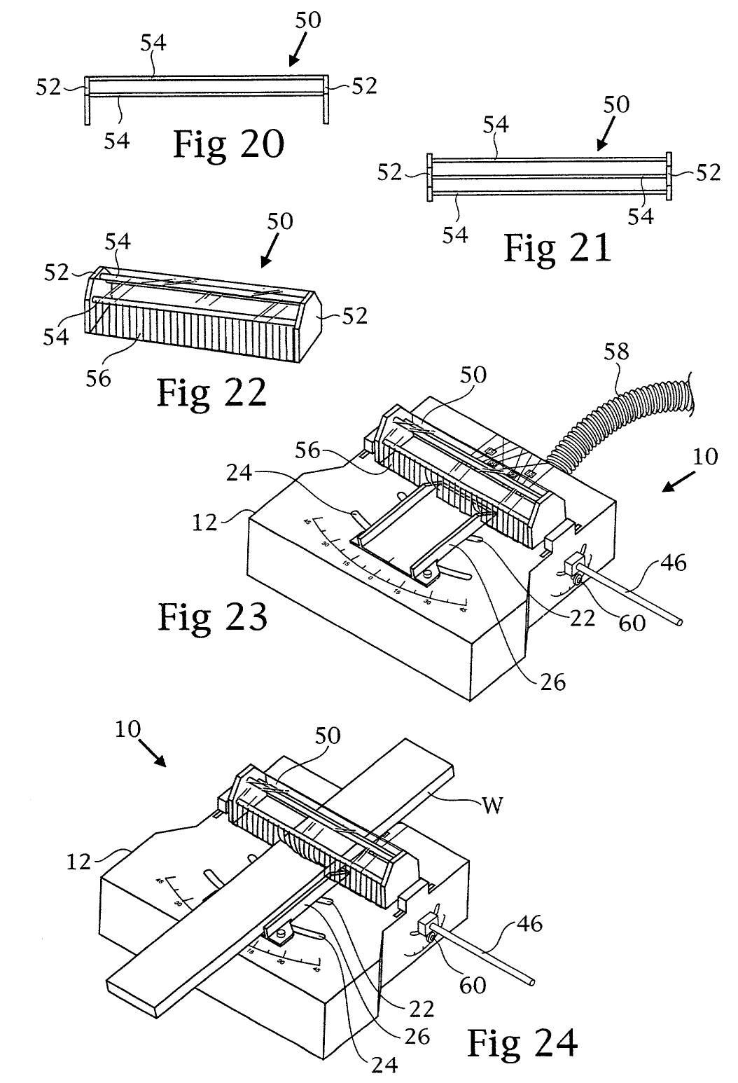

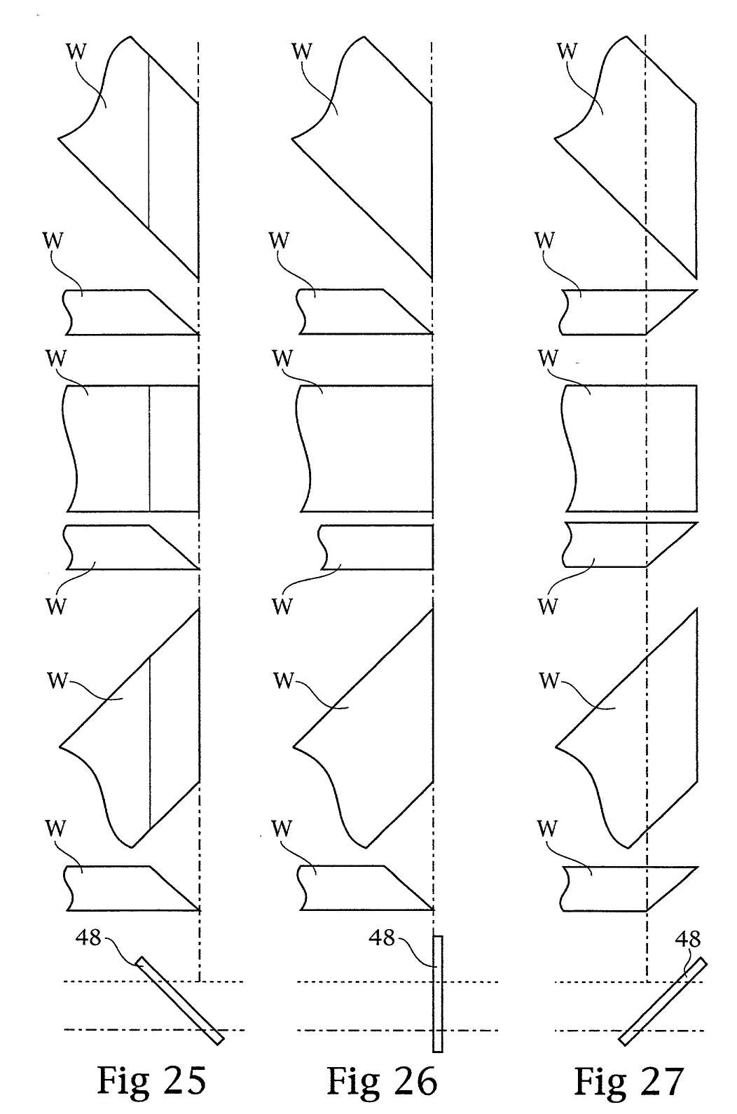

As shown in FIGS. 1, 20-22, a protector 50 is disposed on the top surface 14 of the housing over the elongated opening 20. Preferably, the protector 50 has a frame having two end pieces 52 and at least two shafts 54 therebetween. It is preferred that three shafts 54 be disposed between the end pieces 52. A cover 56 having at least a transparent portion is disposed over the frame. The transparent portion is at the top of the frame so that the cutting operation can be viewed by the operator. The protector also serves to prevent accidental contact with the cutting means 48. The protector may be removable and also may be pivotally mounted along one side so the protector 50 may be pivoted (or flipped) to permit access to the cutting means 38. In this situation, the protector 50 is interlocked to prevent operation of the cutting means 38 when the protector 50 is not in place over the elongated opening 20. The cover 56 extends downwardly over the frame as a curtain to direct debris and sawdust from the cutting operation downwardly through the elongated opening 20 and away from the operator. It is preferred that the downward extending curtain portion of the cover 56 be formed with a plurality of vertical slits to form fingers. The workpiece W may be easily received under the fingers of the cover 56 and the fingers are effective in directing the debris and sawdust.

A source of vacuum 58 is optional and may be connected to the housing 12 to remove the debris and sawdust from the housing (FIG. 23). The source of vacuum may be connected to the housing 12 by a flexible hose inserted into a fitting or opening in the housing 12. Preferably the flexible hose is connected in the vicinity of the elongated opening 20 to more efficiently remove the debris and sawdust.

A typical miter box has dimensions of approximately 15″ ×10″ ×6″, however, the invention is not limited. Smaller miter boxes can be made for hobbyists and larger miter boxes could be made for professional use.

In use, an operator places the workpiece W in the work-holding member 26 with a portion of the workpiece W being disposed under the protector 50 and over the elongated opening 20. The work-holding member 26 is disposed at an angle to provide the selected angle at which the miter cut is desired. The angle can be set between −45° and +45° as indicated on the scale. Miter cuts between 45° and 90° can be made by turning over the workpiece W. For example, turning the workpiece W over and cutting in the opposite direction at 30° can produce a miter cut of 60°. The first end of the work-holding member 26 is aligned with the cut line through the elongated opening 20. The work-holding member 26 is locked in the selected angle by pins, screws, clamps, detent means or other means known to persons skilled in the art.

It is estimated that a tolerance of 1/32″ can be obtained which is equivalent to the accuracy obtainable with a table saw.

The handle of the rod 46 to control the angular disposition of the motor 44 and cutting means 48 is moved to the selected angle. The handle is locked at the selected angle by pins, screws, clamps, detent means or other means 60 known to persons skilled in the art.

The motor 44 is energized by turning on an electrical switch which preferably is mounted on the handle to the rod 46. The switch may be a “trigger” switch. The switch is interlocked with the protector 50 and the motor 44 cannot be energized unless the protector 50 is disposed over the cutting means 46. The source of vacuum, if present, is activated. The operator firmly holds the workpiece W in the work-holding member 26, pressing the workpiece W against one of the side walls 30 of the work-holding member 26. The operator manually moves the handle to the rod 46 by either pushing the handle or pulling the handle so the cutting means 48 engages and cuts the workpiece W at the selected angle. An alternate embodiment has a drive motor connected to the rod 46 to provide for powered longitudinal movement of the rod 46, the motor 44 and the cutting means 48. A separate electrical switch connected to the drive motor is mounted on the miter box 10.

Referring to FIG. 25, with the cutting means 48 at a selected angle of −45°, three modes of disposition of the workpiece W are shown with the resultant cut of the workpiece W viewed from the top and the side of the workpiece W. As can be seen, the present invention provides for compound cutting of the workpiece W with a single action of the cutting means. Both miter cuts and bevel cuts can be made simultaneously. The cut line is shown as a vertical broken line with respect to a base line for the cutting means 48 and the angle of cut is relative to the edge of the workpiece being cut.

Referring to FIG. 26, the cutting means 48 is at an angle of 0° and the workpiece receives only a miter cut and not a bevel cut.

Referring to FIG. 27, the cutting means 48 is at an angle of +45° with respect to the base line of the cutting means. The cut line is shown as a broken vertical line perpendicular to the base line of the cutting means, and because of the negative angle of the cutting means, the bevel cut is away from the major portion of the workpiece. Both miter and bevel cuts are made simultaneously.

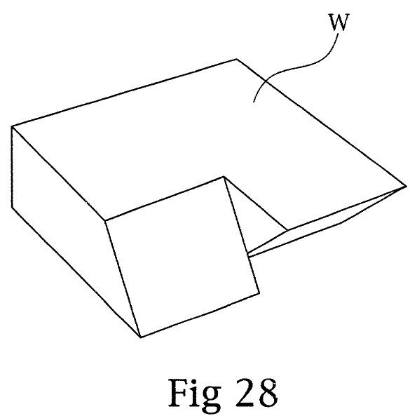

The miter box of the present invention is an extremely versatile, precision device. The support means 38 for the motor 44 allows the cutting means 48 to be drawn through the workpiece W in a straight, unwavering, and precise manner, ensuring the mitered crosscut to be made at the exact desired location. The swivel design of the support means 38 for the motor 44 provides a virtual axis to precisely set the bias of the mitered cut from +45° to −45° relative to the referenced cut line on the workpiece W being cut. The sliding movement of the work-holding member 26 on the top surface 14 of the housing 12 provides two virtual axes to precisely set the angle of the cut of the workpiece from +45° to −45° relative to either edge of the workpiece W. The virtual axis of the bias cut and the virtual axes of the angle cuts are independent of each other thereby allowing precise composite molding miter cuts over the entire adjustable ranges of the bias and angle cuts. The control configuration allows dynamic adjustment of the bias and angle cuts during the cutting process to produce complicated miter cut designs. Thus, as shown in FIG. 28, a bias cut on a single end of a workpiece can be made with a portion cut at 45° and an adjoining portion cut at an angle of −45° (or any combination of angles between +45° and −45°).

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. A miter box comprising:
a housing having a top surface and a plurality of supporting side walls forming an enclosure,
an elongated opening being formed in the top surface of the housing near a first of the supporting side walls,
a work-holding member having a first end, the work-holding member being connected to the top surface of the housing such that the work-holding member may be slidably moved with respect to the top surface of the housing to dispose the first end of the work holding member at a selected angle with respect to the elongated opening in the top surface of the housing,
a plurality of spaced-apart support means disposed in the enclosure under, and approximately parallel to, the elongated opening in the top surface of the housing,
an electrically-powered motor supported on the support means in the enclosure,
a cutting means driven by the electrically-powered motor, the cutting means projecting upwardly into the elongated opening in the top surface of the housing, and
means to move the electrically-powered motor with the cutting means longitudinally within the elongated opening, wherein a workpiece disposed in the work-holding member and extending over the elongated opening is cut at a predetermined angle corresponding to the selected angle of the work-holding member with respect to the elongated opening.

2. The miter box of claim 1, further comprising a rod connected to the electrically-powered motor, the rod extending out of the housing, wherein movement of the rod produces longitudinal movement of the electrically-powered motor such that the cutting means is moved longitudinally with respect to the workpiece.

3. The miter box of claim 1, further comprising means to move the cutting means at a selected angle with respect to a vertical plane through the elongated opening in the top surface, wherein the workpiece extending over the elongated opening is cut at a predetermined angle corresponding to the selected angle of the cutting means such that the workpiece is beveled.

4. The miter box of claim 3, wherein the support means for the electrically-powered motor are mounted between two spaced-apart plates, the plates being rotatable at the selected angle about the vertical plane with respect to the elongated opening such that the cutting means is moved at the corresponding selected angle.

5. The miter box of claim 1, wherein the cutting means is a circular saw blade.

6. The miter box of claim 1, wherein the cutting means is a cutting drill bit.

7. The miter box of claim 1, wherein the work-holding member has a channel shape with open ends such that the workpiece may be held in the work-holding member, without restriction on a length of the workpiece.

8. The miter box of claim 1, further comprising a protector removably disposed over the elongated opening in the top surface of the housing wherein debris from the cutting is directed downwardly through the elongated opening.

9. The miter box of claim 8, wherein the protector has at least a transparent portion providing viewing of the cutting means.

10. The miter box of claim 8, further comprising a vacuum source connected to the housing wherein debris from the cutting is removed from the housing.

11. The miter box of claim 1, further comprising the top surface of the housing having at least two spaced-apart curved tracks thereon, the work-holding member having at least two spaced-apart protrusions extending from a bottom surface of the work-holding member,
the respective protrusions being received in the respective tracks such that the work-holding member is slidably moved and guided by the respective tracks and the work-holding member be disposed at the selected angle with respect to the elongated opening on the top surface of the housing.

12. The miter box of claim 11, wherein the tracks are cut-out portions in the top surface of the housing.

13. The miter box of claim 1, wherein the tracks are raised channels extending above the top surface of the housing.

14. In a power-driven saw machine for making a miter cut, a bevel cut, or a compound miter-bevel cut in a workpiece, wherein the machine includes a housing, a motor within the housing, and a cutting means driven by the motor and projecting above the housing; the improvement comprising a support means within the housing for supporting the motor for movement within the housing, the motor being pivotably disposed with respect to a vertical plane through the housing and being arranged at a desired angular relationship relative to the vertical plane whenever a bevel cut of the workpiece is intended, and a rod connected to the motor and having an end portion projecting externally of the housing, such that the end portion of the rod may be manually manipulated for moving the motor along the support means within the housing for making a cut in the workpiece, the workpiece being supported on top of the housing and being arranged at an angular relationship relative to the cutting means whenever a miter cut of the workpiece is intended.

15. A miter box comprising:
a housing having a top surface, an elongated opening formed in the top surface,
at least two spaced-apart curved tracks formed on the top surface of the housing,
a work-holding member having a bottom surface,
at least two spaced-apart protrusions formed on the bottom surface of the work- holding means,
each of the at least two spaced-apart protrusions being received in a respective track on the top surface of the housing,
wherein the work-holding member may be slidably moved and guided to a selected angle with respect to the elongated opening on the top surface of the housing.
